(19) United States
(12) Patent Application Publication
(10) Pub. No.: US 2008/0070073 A1
(43) Pub. Date: Mar. 20, 2008

(54) FUEL CELL MODULE POWER DELIVERY CONTROL SYSTEM

(76) Inventors: Mark Petersen, North Vancouver (CA); Duhane Lam, Vancouver (CA); Gerard F. McLean, West Vancouver (CA)

Correspondence Address: SCHWEGMAN, LUNDBERG & WOESSNER, P.A., P.O. BOX 2938, MINNEAPOLIS, MN, 55402, US

(21) Appl. No.: 11/533,190

(22) Filed: Sep. 19, 2006

(51) Int. Cl. H01M 8/04; G05D 11/00

(52) U.S. Cl. 429/22; 429/23; 429/24; 700/286; 429/13

(57) ABSTRACT

A fuel cell module power delivery control system monitors the status of a fuel cell module to control power delivery of the fuel cell module, such as to prevent the fuel cell module from reaching an overload condition.

### TECHNICAL FIELD

This patent document pertains generally to fuel cells, and more particularly, but not by way of limitation, to fuel cell module power delivery control systems.

### BACKGROUND

A fuel cell is a device that converts a fuel such as hydrogen or methanol into electricity through an electrochemical reaction. A single fuel cell typically produces about 1.2 volts. Although a single fuel cell can be used by itself, fuel cells are more typically used in conjunction with other fuel cells.

The output voltage of a fuel cell is dependent upon the number of fuel cells serially connected together. The output current of a fuel cell is dependent upon the size of the active area of each fuel cell. In addition, the output voltage of a fuel cell varies according to the load connected to the fuel cell and other factors.

The output power of a fuel cell is limited and dependent upon the number of fuel cells connected together and the size of the active area of each fuel cell. The output power of a fuel cell can also vary depending on environmental conditions, temperature, humidity, manufacturing differences, the condition of the fuel cell, and other factors. Also, the efficiency of a fuel cell is related to the operating voltage of the fuel cell. A higher operating voltage typically equates to a higher fuel cell efficiency.

A fuel cell is fundamentally an unregulated power source. When the load connected to the fuel cell attempts to draw more power than the fuel cell can comfortably provide, the fuel cell output voltage can collapse. A need exists for a fuel cell control system that can control the power being delivered by the fuel cell to the load.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic/block diagram illustrating generally an example of portions of a fuel cell module power delivery control system and portions of an environment in which it is used.

FIG. 2 is a schematic/block diagram illustrating generally an example of fuel cell module status signal components.

FIG. 3 is a schematic/block diagram illustrating generally an example of fuel cell module power delivery control system components.

FIG. 4 is a schematic/block diagram illustrating generally an example of fuel cell module power delivery control system components.

FIG. 5 is a schematic/block diagram illustrating generally an example of portable handheld carrier components.

FIG. 6 is a schematic/block diagram illustrating generally an example of DC-to-DC converter components.

FIG. 7 is a graphical illustration illustrating generally an example of a polarization curve and power curve of a fuel cell.

FIG. 8 is a flow chart illustrating generally an example of portions of a method of use.

FIG. 9 is a flow chart illustrating generally an example of portions of a method of use.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

This document describes, among other things, a fuel cell module power delivery control system that can prevent a fuel cell module from reaching an overload condition. In an overload condition, fuel cell module operation is typically no longer stable, the fuel cell module can be locked out at an inefficient operating point, or the fuel cell module output voltage is at a substantial risk of collapse. A fuel cell module power delivery control system can be configured to allow a load connected to the fuel cell module to draw as much power as the fuel cell module is capable of providing, rather than limiting the fuel cell module to a preset output power.

The fuel cell module power delivery control system can also be realized with fairly minimal functional components, which occupy little space. In certain examples, the fuel cell module power delivery control system and one or more fuel cells (e.g., 11 serially-connected fuel cells) are small, such that they can be implemented in a portable handheld carrier. In certain examples, the fuel cell module power delivery control system is implemented using a DC-to-DC converter with a built-in low battery indicator function and three discrete resistors.

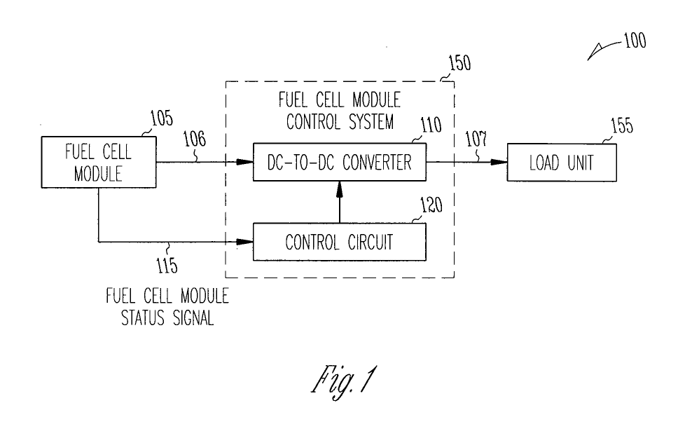

FIG. 1 is a schematic/block diagram illustrating generally, by way of example, but not by way of limitation, certain components of a system 100. In this example, the system 100 includes a fuel cell module power delivery control system 150. In certain examples, the fuel cell module power delivery control system 150 includes a DC-to-DC converter 110 and a separate or integral control circuit 120. A first input of the fuel cell module power delivery control system 150 receives a fuel cell module status signal 115. A second input of the fuel cell module power delivery control system 150 receives a fuel cell module output 106. An output of the fuel cell module power delivery control system 150 provides the DC-to-DC converter output 107, which can be coupled to a load unit 155. In certain examples, the system 100 includes a fuel cell module 105.

The control circuit 120 receives the fuel cell module status signal 115. Generally, the fuel cell module status signal 115 is a signal indicative of the status of the fuel cell module 105. In certain examples, the fuel cell module 105 is a single fuel cell. In other examples, the fuel cell module 105 includes more than one series-connected, parallel-connected, or series-parallel combination-connected fuel cell. The DC-to-DC converter 110 couples the fuel cell module 105 to the load unit 155. The DC-to-DC converter 110 receives a fuel cell module output 106 (e.g., voltage) from the fuel cell module 105 and delivers a resulting lower, higher, or similar output (e.g., voltage) at the DC-to-DC converter output 107 to the load unit 155. The load unit 155 can include a single individual load unit, or multiple individual load units that are connected in series, in parallel, or in a series-parallel combination.

In certain examples, the control circuit 120 can include all or a portion of the DC-to-DC converter 110, which typically includes a linear regulator, a switched-mode DC-to-DC converter, or the like. In certain examples, the DC-to-DC converter 110 includes a custom or off-the shelf monolithic or other DC-to-DC integrated circuit, such as a Texas Instruments TPS62050, or a Maxim MAX640, or a Linear Technology LT1705, or the like.

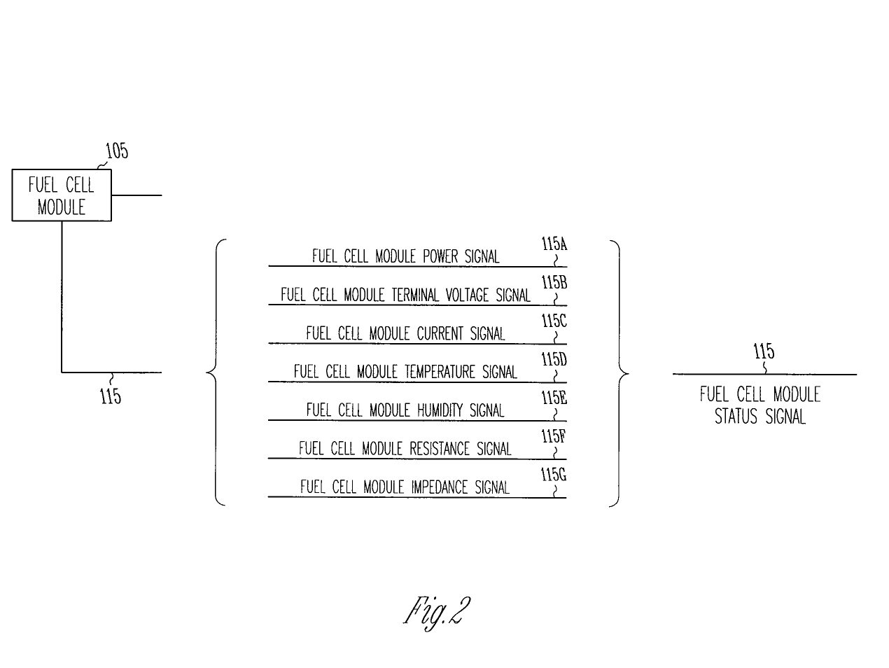

FIG. 2 is a schematic/block diagram illustrating generally examples of a suitable fuel cell module status signal 115. Generally, the fuel cell module status signal 115 is a signal indicative of the status of fuel cell module 105, e.g., fuel cell module power, fuel cell module terminal voltage, etc. In one example, the fuel cell module status signal 115 includes a fuel cell module power signal 115a, which is indicative of fuel cell module power. In another example, the fuel cell module status signal 115 includes a fuel cell module terminal voltage signal 115b, which is indicative of fuel cell module terminal voltage. In another example, the fuel cell module status signal 115 includes a fuel cell module current signal 115c, which is indicative of fuel cell module current. In another example, the fuel cell module status signal 115 includes a fuel cell module temperature signal 115d, which is indicative of fuel cell module temperature. In another example, the fuel cell module status signal 115 includes a fuel cell module humidity signal 115e, which is indicative of fuel cell module humidity. In another example, the fuel cell module status signal 115 includes a fuel cell module resistance signal 115f, which is indicative of fuel cell module resistance. In another example, the fuel cell module status signal 115 includes a fuel cell module impedance signal 115g, which is indicative of fuel cell module impedance. In yet another example, the fuel cell module status signal 115 includes a signal indicative of a combination of at least two of a fuel cell module power, a fuel cell module terminal voltage, a fuel cell module current, a fuel cell module temperature, a fuel cell module humidity, a fuel cell module resistance, and a fuel cell module impedance.

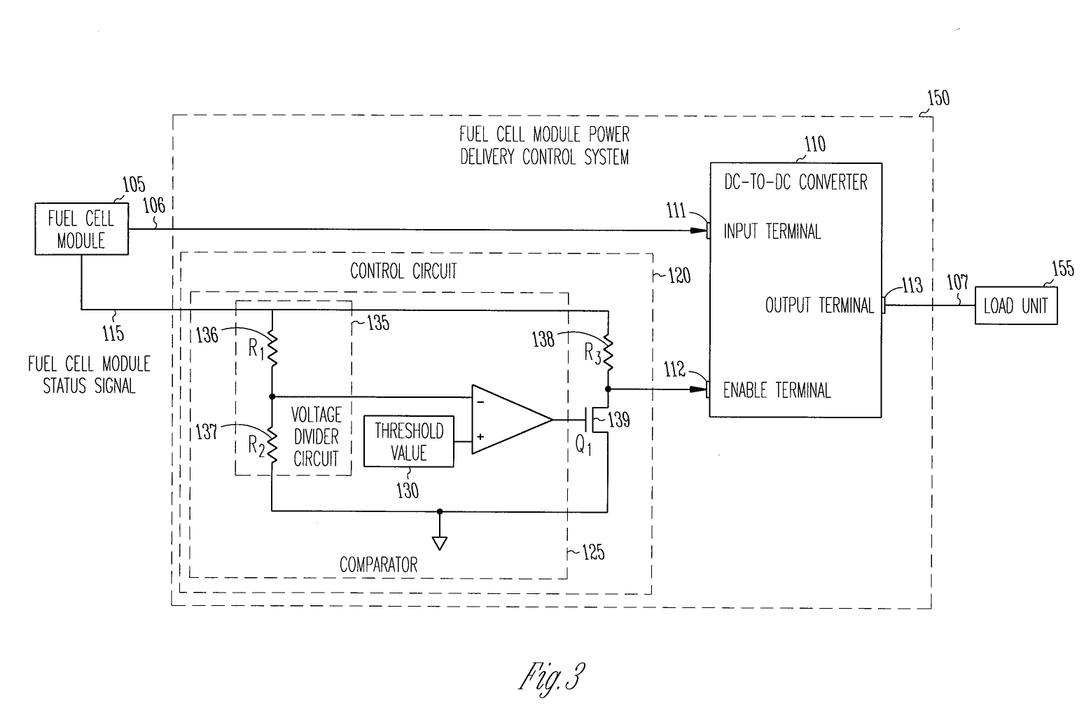

FIG. 3 is a schematic/block diagram illustrating generally an example of the fuel cell module power delivery control system 150, including the control circuit 120 and the DC-to-DC converter 110. In this example, the DC-to-DC converter 110 receives the fuel cell module output 106 at a DC-to-DC converter input terminal 111. The load unit 155 receives the DC-to-DC converter output 107 at a DC-to-DC converter output terminal 113. In this example, the control circuit 120 typically includes a comparator 125, a pull-up resistor (R3) 138 and a switch (Q1) 139. The comparator 125 uses a voltage divider circuit 135, such as formed using fixed or adjustable resistors R1 136 and R2 137.

In certain examples, the voltage divider circuit 135 is automatically or user adjustable. The voltage divider circuit 135 can be static, or dependent upon the fuel cell module 105. For example, the voltage divider circuit 135 can be dependent upon the number of individual fuel cells included in the fuel cell module 105, or fuel cell module configuration (e.g., fuel cell connection in series, parallel, or a series-parallel combination). Additionally or alternatively, the voltage divider circuit 135 can be dependent upon fuel cell module operation, such as one or more operating conditions (e.g., temperature, humidity), or power delivery mode (e.g., efficiency, maximum power draw).

In certain examples, the comparator 125 receives, at a first comparator input, a voltage-divided or other signal indicative of the fuel cell module status signal 115, and compares it to a threshold value 130 received at a second comparator input. The threshold value 130 can be automatically or user adjustable or an automatically defined or user-defined static value. The threshold value 130 can be dependent upon one or more attributes of the fuel cell module 105, such as the number of individual fuel cells included in the fuel cell module 105, or fuel cell module configuration (e.g., fuel cell connection in series, parallel, or a series-parallel combination) or fuel cell module operation such as operating condition (e.g., temperature, humidity), or power delivery mode (e.g., efficiency, maximum power draw).

In certain examples, if the output of the voltage divider circuit 135 falls below the threshold value 130, the output of the comparator 125 closes a switch (Q1) 139, such as a field-effect or other transistor. Closing the switch (Q1) 139 allows the current provided by the fuel cell module status signal 115 to flow to ground through resistor R3, which pulls low the output of control circuit 120. When the output of the voltage divider circuit 135 exceeds the threshold value 130, the output of the comparator 125 opens the switch (Q1) 139. Opening the switch (Q1) 139 pulls the output voltage of the control circuit 120 to be equal to or approximately equal to the voltage of the fuel cell module status signal 115.

In certain examples, the DC-to-DC converter 110 includes an enable/disable feature, such as provided by an enable terminal 112. If the enable terminal 112 receives a logic high signal, the DC-to-DC converter 110 is enabled, or operable. If the enable terminal 112 receives a logic low signal, the DC-to-DC converter 110 is disabled, or non-operable.

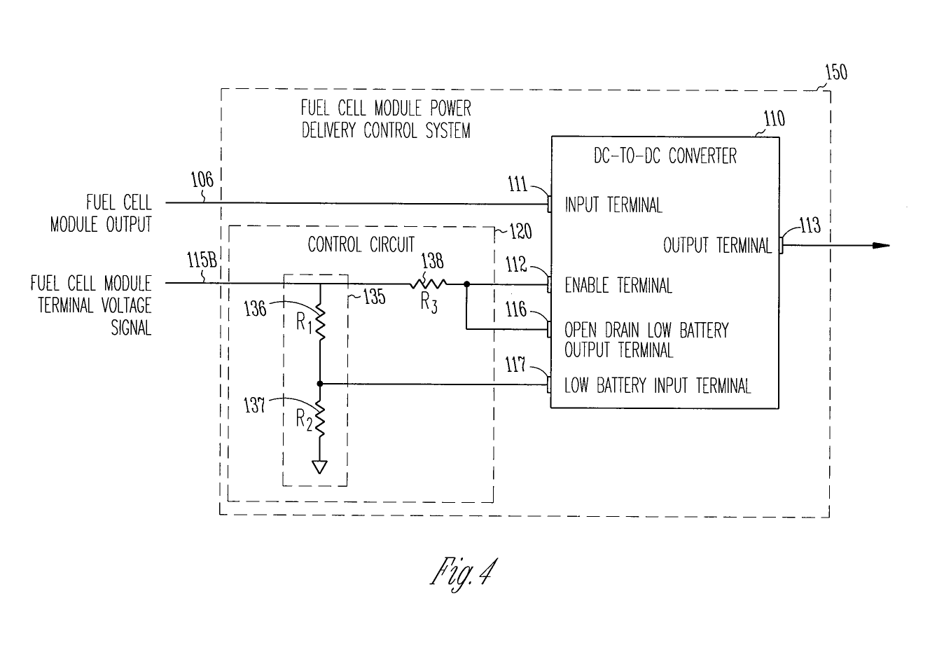

FIG. 4 is a schematic/block diagram illustrating generally an example of the fuel cell module power delivery control system 150, including the control circuit 120 and the DC-to-DC converter 110. In certain examples, the control circuit 120 includes at least one active or passive discrete component, such as the three discrete components in the example of FIG. 4. The three discrete components can include a resistor, for example, FIG. 4 shows a voltage divider (e.g. R1 136 and R2 137) and a pull-up resistor (e.g. R3 138).

In certain examples, the DC-to-DC converter 110 includes a low battery feature. The low battery feature can include a logic high/low input (e.g., a low battery input terminal 117) and an open drain output (e.g., an open drain low battery output terminal 116). The low battery feature can operate as a comparator with a low battery value of “logic low”. When the signal to the low battery input terminal 117 drops to or below a “logic low” level, an open drain output is operable at the open drain low battery output terminal 116. The DC-to-DC converter 110 generally includes an enable/disable feature, such as the enable terminal 112. The open drain low battery output terminal 116 is typically connected to the enable terminal 112. When the signal provided to the low battery input terminal 117 drops to or below a “logic low” level, the DC-to-DC converter 110 is disabled. When DC-to-DC converter 110 is disabled, its current consumption is low, e.g., about 2 μA. Disabling the DC-to-DC converter 110 effectively detaches the fuel cell module 105 from the load unit 155, thereby allowing the fuel cell module 105 to recover to a more desirable operating point. The control circuit 120 can provide the fuel cell module status signal 115 to the low battery input terminal 117 to enable or disable the DC-to-DC converter 110 to couple or decouple the fuel cell module 105 to or from the load unit 155.

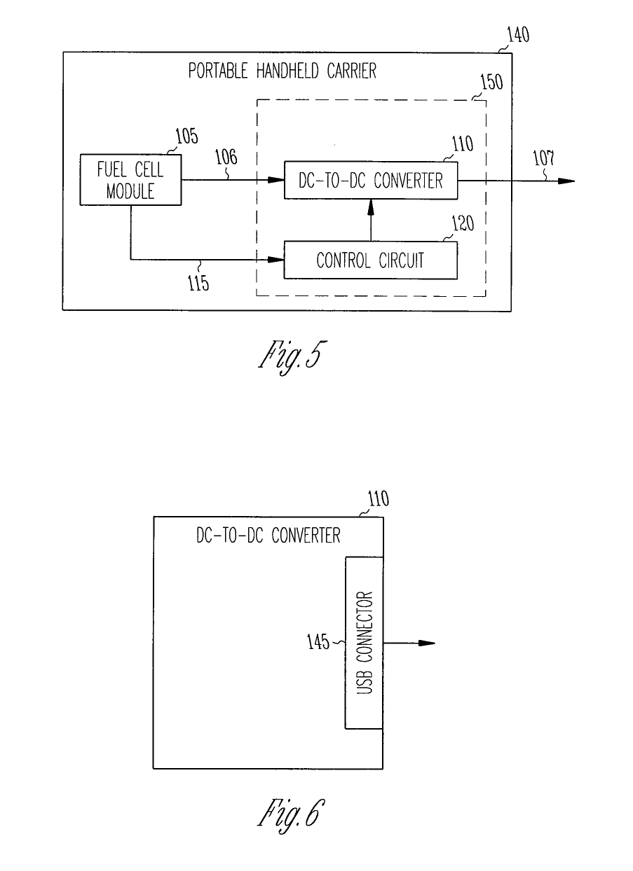

FIG. 5 is a schematic/block diagram illustrating generally an example of packaging the fuel cell module 105 and the fuel cell module power delivery control system 150 in a portable handheld carrier 140. In certain examples, the portable handheld carrier 140 is small enough to be held in a user's hand. For such portable applications, a small-sized fuel cell module 105 is used, with such a fuel cell module 105 typically capable of generating a DC voltage output of less than or equal to 60 Volts and a power output of less than or equal to 240 Watts. In other examples, the fuel cell module 105 is capable of generating a power output range from 0.01 to 10 Watts, from 0.01 to 100 Watts, or from 0.01 to 1000 Watts.

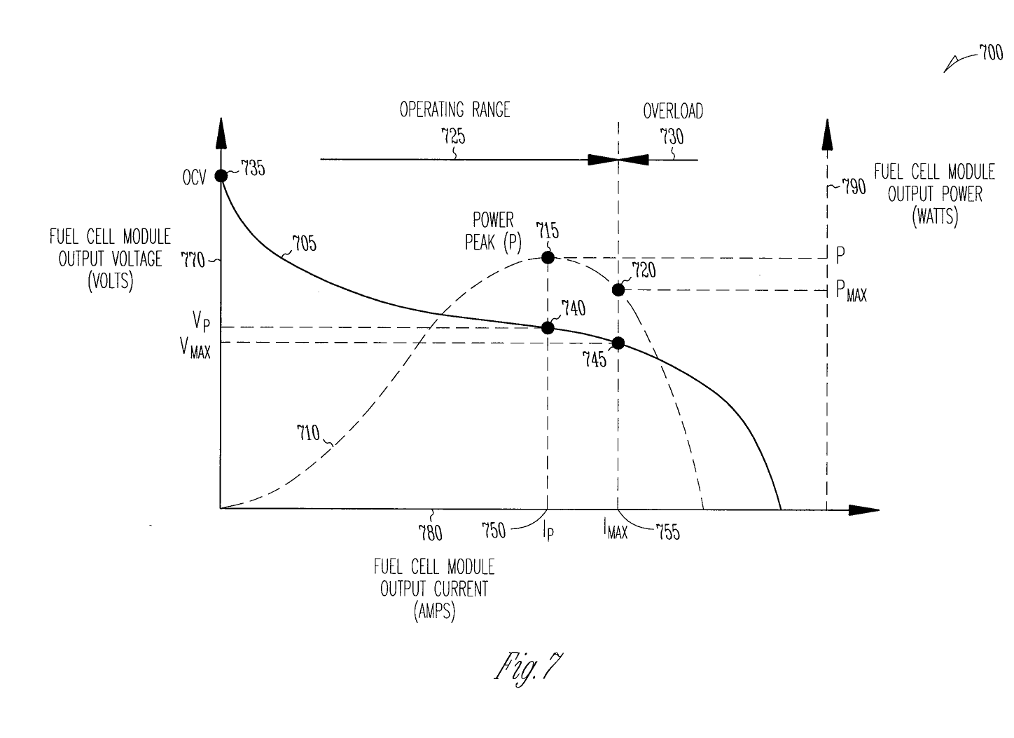

FIG. 6 is a schematic/block diagram illustrating generally an example of the DC-to-DC converter 110 including a universal serial bus (USB) connector 145, such as for use by the DC-to-DC converter 110 for connecting through a USB cable to a load unit 155, which typically includes a USB input terminal. Thus, the load unit 155 can include an electronic device capable of receiving power through a USB terminal, e.g., a cellular telephone, digital camera, etc.

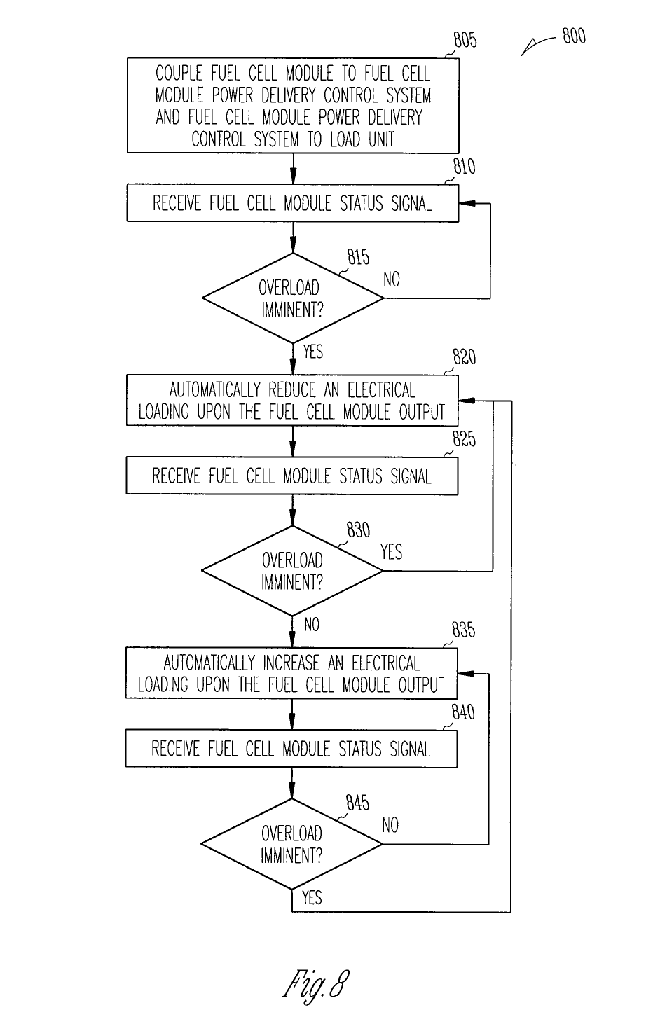

FIG. 7 is a graphical conceptual illustration 700 illustrating generally a polarization curve 705 and a power curve 710 of a fuel cell module 105. The left vertical axis of the graph 700 shows a fuel cell module output voltage (Volts) 770, the horizontal axis of the graph 700 shows fuel cell module output current (Amps) 780, and the right vertical axis of the graph 700 shows fuel cell module output power (Watts) 790. The fuel cell module output voltage 770 starts at an open circuit voltage (OCV) 735. In one example, the OCV can be approximately 0.77 Volts per fuel cell, e.g., for 11 serially-connected fuel cells, the OCV can be approximately 8.5 to 10.5 Volts).

Generally, referring to the polarization curve 705 and the power curve 710, the fuel cell module output voltage 770 decreases and the fuel cell module output power 790 increases as the fuel cell module output current 780 increases. As the fuel cell module output current 780 increases, the power curve 710 reaches the power peak (P) 715, or maximum fuel cell module power output. The power peak 715 of the power curve 710 corresponds to a fuel cell module output voltage at the power peak 715 of V_{P} 740, and a fuel cell module output current at the power peak 715 of I_{P} 750. In one example, V_{P} 740 is approximately 0.3 to 0.5 Volts per fuel cell, e.g., for 11 serially-connected fuel cells, V_{P} 740 is approximately 3.3 to 5.5 Volts.

The load unit 155 may attempt to draw more power from the fuel cell module 105 than it can comfortably provide. When this happens, the fuel cell module output voltage 770 may drop below V_{P} 740 and the fuel cell module output current may rise above I_{P} 750. This situation may pose several problems. In the extreme, a short circuit in the load unit 155 may cause V_{P} 740 to collapse to zero. First, the efficiency of the fuel cell module 105 is typically dependent on its operating voltage. Generally, the closer that the fuel cell module 105 operates to OCV 735, the higher its efficiency. At lower operating voltages, the fuel cell module 105 is typically less efficient, which, in general, means that more heat is generated for each unit of electricity produced. Secondly, once the fuel cell module 105 goes over the power peak 715, it may be difficult for it to recover to a higher operating voltage.

When the fuel cell module output voltage 770 is higher than V_{P} 740 and the fuel cell module output current 780 is lower than I_{P} 750, increasing the load on the fuel cell module 105 will typically increase the fuel cell module output current 780, decrease the fuel cell module output voltage 770, and increase the fuel cell module output power 790. When the fuel cell module output voltage 770 is lower than V_{P} 740 and the fuel cell module output current is higher than I_{P} 750, increasing the load on the fuel cell module 105 will typically increase the fuel cell module output current 780, decrease the fuel cell module output voltage 770, and decrease the fuel cell module output power 790. This reduction in the fuel cell module output power 790 may cause the load unit 155 to attempt to draw even more power by even greater increases in the fuel cell module output current 780 and reductions in the fuel cell module output voltage 770, which typically reduces the fuel cell module output power 790 even further. In the extreme, this power draw by the load unit 155 creates an overload condition on the fuel cell module 105.

Generally, once the fuel cell module 105 is operating over and beyond the top of the power peak 715, it can be difficult for the fuel cell module 105 to recover to a more efficient operating point above V_{P} 740. When the fuel cell module 105 is operating over the top of the power peak 715, if the power draw on the fuel cell module 105 is reduced, the fuel cell module 105 can tend to want to move its operating point toward the right on the power curve 710 rather than toward the left, because moving right on the power curve 710 reduces the fuel cell module output power 790. However, moving right on the power curve 710 also corresponds to an increased current draw and a decreased fuel cell module operating voltage.

Referring to the power curve 710, the same fuel cell module output power can be realized at two different values of the fuel cell module output current and two different values of the fuel cell module output voltage, one on the left side of the power peak 715 and one on the right side of the power peak 715. Typically, fuel cell module 105 operation is preferred to be on the left side of the power peak 715, or only slightly over the power peak 715 (e.g., within 25% past the power peak 715). This range is shown in FIG. 7 as the operating range 725, having a maximum range corresponding to a fuel cell module output power 790 of Pₘₐₓ 720, a fuel cell module output voltage 770 of Vₘₐₓ 745, and a fuel cell module output current 780 of Iₘₐₓ 755.

Generally, it can be difficult for the fuel cell module 105 to “tunnel” through to the equivalent fuel cell module output power on the left side of the power peak 715 once it has exceeded the power peak 715 to a certain extent (e.g., more than 25% past the power peak 715). Once the fuel cell module output power 790 exceeds the power peak 715 to such an extent, its operating point effectively becomes “locked out” on the right side of the power peak 715, shown in FIG. 7 as an overload 730. Once the fuel cell module 105 has reached overload 730, the load on the fuel cell module 105 must be practically turned off, greatly reduced, or even disconnected to permit recovery of the fuel cell module 105 to a more efficient operating point on the left side of the power peak 715.

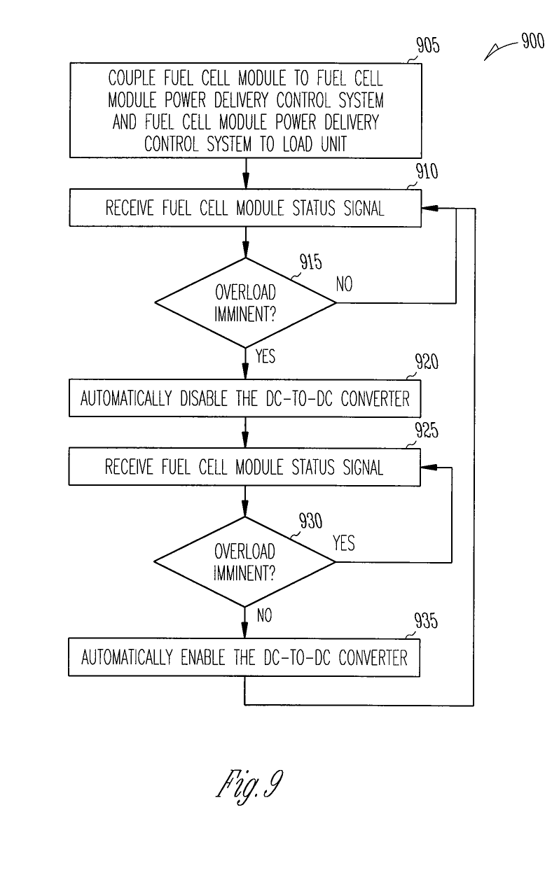

FIG. 8 is a flow chart illustrating generally an example of implementing a method 800. At 805, the fuel cell module 105 is coupled to the fuel cell module power delivery control system 150, and the fuel cell module power delivery control system 150 is coupled to the load unit 155.

At 810, the fuel cell module power delivery control system 150 receives the fuel cell module status signal 115, such as upon activation of the method 800, or in response to a user input or a triggering event.

At 815, the fuel cell module power delivery control system 150 determines if overload 730 is imminent, such as by using a comparator 125, which can be included in the control circuit 120, such as within the DC-to-DC converter 110. In such an example, the comparator 125 compares the fuel cell module status signal 115 to a static or adjustable threshold value 130, such as a preset or adjustable low battery value provided by the DC-to-DC converter 110. If, at 815, the fuel cell module power delivery control system 150 determines that overload 730 is not imminent, then process flow returns to 810. If, at 815, the fuel cell module power delivery control system 150 determines that overload 730 is imminent, then process flow continues to 820.

At 820, the fuel cell module power delivery control system 150 automatically reduces an electrical loading upon the output of the fuel cell module 105. This can include reducing the current through the DC-to-DC converter 110, such as by using its enabling/disabling function to cycle the DC-to-DC converter 110 on and off. Additionally or alternatively, this can include reducing the current draw of the load unit 155, such as by increasing a current-limiting resistance to the load unit 155.

At 825, the fuel cell module power delivery control system 150 receives the fuel cell module status signal 115. At 830, the fuel cell module power delivery control system 150 determines if overload 730 is imminent. If, at 830, the fuel cell module power delivery control system 150 determines that overload 730 is imminent, then process flow returns to 820. If, at 830, the fuel cell module power delivery control system 150 determines that overload 730 is no longer imminent, then process flow continues to 835.

At 835, the fuel cell module power delivery control system 150 automatically permits increased electrical loading upon the fuel cell module output, such as by allowing increased current draw of the load unit 155 or through the DC-to-DC converter 110.

At 840, the fuel cell module power delivery control system 150 receives the fuel cell module status signal 115. At 845, the fuel cell module power delivery control system 150 uses the fuel cell module status signal 115 to determine if overload 730 is imminent. If, at 845, the fuel cell module power delivery control system 150 determines that overload 730 is not imminent, then process flow returns to 835. If, at 845, the fuel cell module power delivery control system 150 determines that overload 730 is imminent, then process flow returns to 820.

FIG. 9 is a flow chart illustrating generally an example of implementing a method 900. At 905, the fuel cell module 105 is coupled to the fuel cell module power delivery control system 150, and the fuel cell module power delivery control system 150 is coupled to the load unit 155.

At 910, the fuel cell module power delivery control system 150 receives the fuel cell module status signal 115, such as upon system activation, in response to a user input, or in response to a triggering event.

At 915, the fuel cell module power delivery control system 150 determines if overload 730 is imminent, such as by using the comparator 125 included in the control circuit 120 or the DC-to-DC converter 110. In certain examples, the comparator 125 compares the fuel cell module status signal 115 to a static or adjustable threshold value 130, which can be provided by a built-in low battery voltage circuit on the DC-to-DC converter 110. If, at 915, the fuel cell module power delivery control system 150 determines that overload 730 is not imminent, then process flow returns to 910. If, at 915, the fuel cell module power delivery control system 150 determines that overload 730 is imminent, then process flow continues to 920.

At 920, the fuel cell module power delivery control system 150 automatically disables the DC-to-DC converter 110, such as by using an enable/disable input on the DC-to-DC converter 110 or by using a low battery input on the DC-to-DC converter 110.

At 925, the fuel cell module power delivery control system 150 receives the fuel cell module status signal 115. At 930, the fuel cell module power delivery control system 150 determines if overload 730 is imminent. If, at 930, fuel cell module power delivery control system 150 determines that overload 730 is imminent, then process flow returns to 925. If, at 930, the fuel cell module power delivery control system 150 determines that overload 730 is no longer imminent, then process flow continues to 935.

At 935, the fuel cell module power delivery control system 150 automatically enables the DC-to-DC converter 110, such as by using an enable/disable input on the DC-to-DC converter 110, or by using a low battery input on DC-to-DC converter 110. Process flow then returns to 910.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A system comprising:
a fuel cell control system, comprising:
a DC-to-DC converter, including a DC-to-DC converter input configured to be coupled to at least one fuel cell and a DC-to-DC converter output configured to be coupled to at least one load unit; and
a control circuit, coupled to or including at least a portion of the DC-to-DC converter to control the DC-to-DC converter, the control circuit including at least one fuel cell status input configured to be coupled to the at least one fuel cell to receive a fuel cell status signal indicative of a status of the at least one fuel cell, and wherein the control circuit is configured to restrict power delivery by the at least one fuel cell to remain within a specified operating range by using the fuel cell status signal, the control circuit configured such that:
when the fuel cell status signal indicates that an overload condition is imminent, automatically reducing an electrical loading upon the at least one fuel cell output or automatically disabling the DC-to-DC converter; and
when the fuel cell status signal indicates that the overload condition is no longer imminent, automatically increasing an electrical loading upon the at least one fuel cell output or automatically enabling the DC-to-DC converter; and
wherein the control circuit is configured to restrict power delivery without requiring a microprocessor to control switching of the DC-to-DC converter.

2. The system of claim 1, wherein the control circuit is configured to restrict power delivery by the at least one fuel cell to remain within a specified operating range by using the fuel cell status signal, the control circuit configured such that when the fuel cell status signal indicates that an overload condition is imminent, automatically reducing an electrical loading upon the at least one fuel cell output, and when the fuel cell status signal indicates that the overload condition is no longer imminent, automatically increasing an electrical loading upon the at least one fuel cell output.

3. The system of claim 1, wherein the control circuit is configured to restrict power delivery by the at least one fuel cell to remain within a specified operating range by using the fuel cell status signal, the control circuit configured such that when the fuel cell status signal indicates that an overload condition is imminent, automatically disabling the DC-to-DC converter, and when the fuel cell status signal indicates that the overload condition is no longer imminent, automatically enabling the DC-to-DC converter.

4. The system of claim 3, wherein the DC-to-DC converter is a switching DC-to-DC converter.

5. The system of claim 3, wherein the DC-to-DC converter includes a monolithic DC-to-DC integrated circuit that includes a built-in comparator and reference voltage generator that are used by the control circuit to control the DC-to-DC converter, wherein the comparator includes a comparator input coupled to the fuel cell to receive the fuel cell status signal, and a comparator output that is coupled to an enable input of the DC-to-DC to enable or disable the DC-to-DC converter to respectively couple or decouple the at least one fuel cell to the at least one load unit.

6. The system of claim 1, wherein the control circuit is configured to restrict power delivery by the at least one fuel cell to remain within a specified operating range having a maximum operating range that does not exceed 25% past the peak power value of a power curve of the at least one fuel cell.

7. The system of claim 1, wherein the control circuit is configured to restrict power delivery by the at least one fuel cell to remain within a specified operating range having a maximum operating power that is less than the peak power value of the polarization curve of the at least one fuel cell.

8. The system of claim 1, comprising the at least one fuel cell.

9. The system of claim 1, comprising the load unit.

10. The system of claim 1, wherein the fuel cell status signal comprises at least one of a fuel cell power, a fuel cell terminal voltage, a fuel cell current, a fuel cell temperature, a fuel cell humidity, a fuel cell resistance, and a fuel cell impedance.

11. The system of claim 10, wherein the fuel cell status signal comprises at least one of a fuel cell power, a fuel cell terminal voltage, and a fuel cell current.

12. The system of claim 11, wherein the fuel cell status signal comprises a fuel cell terminal voltage.

13. The system of claim 12, wherein the control circuit is configured to maintain the fuel cell terminal voltage greater than 0.3 Volts per fuel cell in the at least one fuel cell, wherein the at least one fuel cell includes a series arrangement of at least one fuel cell in the series arrangement.

14. The system of claim 1, wherein the control circuit includes a comparator to compare the fuel cell status signal to a threshold value.

15. The system of claim 14, wherein the threshold value is user-adjustable.

16. The system of claim 14, wherein the threshold value is automatically adjustable.

17. The system of claim 1, wherein the DC-to-DC converter output includes a Universal Serial Bus (USB) connector for coupling to the load unit.

18. The system of claim 1, comprising a portable handheld carrier that incorporates the at least one fuel cell and the control circuit.

19. The system of claim 1, comprising a power output of less than or equal to 240 Watts and a DC voltage output of less than or equal to 60 Volts.

20. The system of claim 1, comprising a power output of less than 100 Watts.

21. The system of claim 20, comprising a power output of less than 10 Watts.

22. A system comprising:
means for controlling at least one fuel cell, comprising:
means for coupling at least one DC-to-DC converter input to the at least one fuel cell and at least one DC-to-DC converter output to at least one load unit;
means for receiving at least one fuel cell status signal from the at least one fuel cell; and
means for restricting power delivery of the at least one fuel cell to remain within a specified operating range using the at least one fuel cell status signal.

23. A method comprising:
controlling at least one fuel cell, comprising:
coupling at least one DC-to-DC converter input to the at least one fuel cell and at least one DC-to-DC converter output to at least one load unit;
receiving at least one fuel cell status signal from the at least one fuel cell;
restricting power delivery of the at least one fuel cell to remain within a specified operating range using the at least one fuel cell status signal;
wherein restricting power delivery of the at least one fuel cell includes automatically reducing an electrical loading upon the at least one fuel cell output or automatically disabling the DC-to-DC converter when the fuel cell status signal indicates that an overload condition is imminent, and automatically increasing an electrical loading upon the at least one fuel cell output or automatically enabling the DC-to-DC converter when the fuel cell status signal indicates that the overload condition is no longer imminent; and
wherein restricting power delivery of the at least one fuel cell includes restricting power delivery without requiring a microprocessor to control switching of the DC-to-DC converter.

24. The method of claim 23, wherein restricting power delivery of the at least one fuel cell includes automatically reducing an electrical loading upon the at least one fuel cell output when the fuel cell status signal indicates that an overload condition is imminent, and automatically increasing an electrical loading upon the at least one fuel cell output when the fuel cell status signal indicates that the overload condition is no longer imminent.

25. The method of claim 23, wherein restricting power delivery of the at least one fuel cell includes automatically disabling the DC-to-DC converter when the fuel cell status signal indicates that an overload condition is imminent, and automatically enabling the DC-to-DC converter when the fuel cell status signal indicates that the overload condition is no longer imminent.

26. The method of claim 25, wherein disabling or enabling the DC-to-DC converter includes disabling or enabling a switching DC-to-DC converter.

27. The method of claim 25, wherein restricting power delivery of the at least one fuel cell to remain within a specified operating range includes comparing a fuel cell status signal to a reference using a monolithic DC-to-DC integrated circuit that includes a built-in comparator and reference voltage generator, wherein comparing a fuel cell status signal includes enabling or disabling the DC-to-DC converter to respectively couple or decouple the at least one fuel cell to the at least one load unit.

28. The method of claim 23, wherein restricting power delivery of the at least one fuel cell to remain within a specified operating range includes restricting power delivery of the fuel cell to not exceed 25% past the peak power value of a polarization curve of the at least one fuel cell.

29. The method of claim 23, wherein restricting power delivery of the at least one fuel cell to remain within a specified operating range includes restricting power delivery of the fuel cell to not exceed the peak power value of a polarization curve of the at least one fuel cell.

30. The method of claim 23, wherein receiving at least one fuel cell status signal comprises receiving at least one of a fuel cell power, a fuel cell terminal voltage, a fuel cell current, a fuel cell temperature, a fuel cell humidity, a fuel cell resistance, and a fuel cell impedance.

31. The method of claim 30, wherein receiving at least one fuel cell status signal comprises receiving at least one of a fuel cell power, a fuel cell terminal voltage, and a fuel cell current.

32. The method of claim 31, wherein receiving at least one fuel cell status signal comprises receiving a fuel cell terminal voltage.

33. The method of claim 32, wherein restricting power delivery of the at least one fuel cell to remain within a specified operating range includes maintaining a fuel cell terminal voltage greater than 0.3 Volts per fuel cell in the at least one fuel cell.

34. The method of claim 23, wherein restricting power delivery of the at least one fuel cell to remain within a specified operating range includes comparing the fuel cell status signal to a threshold value.

35. The method of claim 34, wherein comparing a fuel cell status signal to a threshold value includes comparing a fuel cell status signal to a user-adjustable threshold value.

36. The method of claim 34, wherein comparing a fuel cell status signal to a threshold value includes comparing a fuel cell status signal to an automatically adjustable threshold value.

37. The method of claim 23, wherein coupling at least one DC-to-DC converter output to at least one load unit includes coupling at least one DC-to-DC converter output to at least one load unit using a Universal Serial Bus (USB) connector.

38. The method of claim 23, comprising controlling the at least one fuel cell in portable handheld carrier.

39. The method of claim 23, comprising generating a power output of less than or equal to 240 Watts and a DC voltage output of less than or equal to 60 Volts.

40. The method of claim 23, comprising generating a power output of less than 100 Watts.

41. The method of claim 40, comprising generating a power output of less than 10 Watts.
